(19) United States
(12) Patent Application Publication
(10) Pub. No.: US 2025/0083300 A1
(43) Pub. Date: Mar. 13, 2025

(54) GOLF COURSE GRABBER DEVICE

(71) Applicant: David Myers, Yorktown, IN (US)

(72) Inventor: David Myers, Yorktown, IN (US)

(21) Appl. No.: 18/822,628

(22) Filed: Sep. 3, 2024

Related U.S. Application Data
(60) Provisional application No. 63/537,606, filed on Sep. 11, 2023.

(51) Int. Cl. B25J 1/04; A63B 57/50

(52) U.S. Cl. CPC B25J 1/04; A63B 57/50

(57) ABSTRACT

A grabbing device for grabbing an object from a distance. The grabbing device may include a handle with a moveable section and a fixed section. The moveable section may be coupled to the fixed section. The grabbing device may also include a head assembly with one or more elongated members configured to grab an object. The head assembly may have a shaft coupled to the handle at a proximal end and removably coupled to the head assembly at a distal end, wherein the head assembly may be removed and replaced with an alternative head assembly.

### RELATED APPLICATIONS

The present application claims the benefit of U.S. Provisional Patent Application Ser. No. 63/537,606, filed Sep. 11, 2023, the disclosure of which is hereby incorporated by reference in its entirety.

### FIELD OF THE DISCLOSURE

The present disclosure relates to grabbing devices designed to engage objects from remote distances, in particular, to grabbing devices used while on a lawn mower.

### BACKGROUND

Grabbing devices may be used to grab and release objects from a remote distance. Various situations arise where the need to not only grab and release objects from a distance occurs, but when an operator needs to secure the grabbed object into a desired location with a force before releasing it. One such example is when an operator is mowing a tee box. In this example, the operator may desire not only to grab the tee marker from a distance, but to also push the tee marker back into the ground from a distance. In some instances, it would be desirable for the operator to be able to remove and insert the tee marker while sitting on a lawn mower. It would be desirable to have a grabbing device that can not only grab an object from a distance, but can also insert or “push” the object into a desired location.

### SUMMARY

According to an aspect of the present disclosure, there is a grabbing device for grabbing an object from a distance. The grabbing device may include a handle with a moveable section and a fixed section, the moveable section being coupled to the fixed section. The grabbing device may include one or more elongated members configured to grab an object. The grabbing device may also include a shaft coupled to the handle at a proximal end and removably coupled to the head assembly at a distal end, wherein the head assembly may be removed and replaced with an alternative head assembly.

In one implementation, there is provided a grabbing device for grabbing an object from a distance. The grabbing device includes a handle having a moveable section and a fixed section, wherein the moveable section is moveably coupled to the fixed section. A head assembly with a plurality of elongated members is configured to grab an object. A shaft is coupled to the handle at a proximal end of the shaft and is removably coupled to the head assembly at a distal end of the shaft, wherein the head assembly may be removed and replaced with an alternative head assembly.

In some implementations, the grabbing device further includes wherein each of the plurality of elongated members has a divergent distal end and each of the distal ends of the plurality of elongated members is configured to slide over the object.

In some implementations, the grabbing device further includes wherein the head assembly has a pivot plate and each of the plurality of elongated members is pivotably coupled to the pivot plate.

In some implementations, the grabbing device further includes wherein the pivot plate includes a plurality of arms, wherein one of the plurality of elongated members is pivotally coupled to one of the plurality of arms.

In some implementations, the grabbing device further includes wherein the pivot plate includes a channel extending through the pivot plate and each of the plurality of arms extends from the channel.

In some implementations, the grabbing device further includes wherein the shaft includes an actuating shaft coupled to the moveable section of the handle.

In some implementations, the grabbing device further includes a spring, wherein the actuating shaft extends through the spring and actuation of the moveable section compresses the spring to extend the plurality of arms toward a central axis defined by the device.

In some implementations, the grabbing device further includes wherein the channel includes a first aperture and a second aperture, wherein the handle is coupled to the first aperture by a main shaft of the shaft and the spring is located in the second aperture.

In some implementations, the grabbing device further includes wherein a release of the handle decompresses the spring and moves the plurality of elongated members away from the central axis.

In some implementations, the grabbing device further includes further comprising a main shaft, wherein the actuating shaft is positioned at least partially within the main shaft and moveable relative to the main shaft.

In some implementations, the grabbing device further includes wherein the fixed section of the handle is coupled to the main shaft.

In another implementation, there is provided a golf course grabbing device for grabbing a tee marker located on a golf course. The golf course grabbing device includes a handle having a moveable section and a fixed section. The moveable section is movably coupled to the fixed section. A main shaft is coupled to the fixed section, wherein the main shaft defines a device central axis. A head assembly is coupled to the main shaft and includes a pivot plate. A plurality of elongated members is pivotally coupled the pivot plate, wherein each of the plurality of elongated members includes a divergent shape configured to engage the tee marker.

In some implementations, the golf course grabbing device further includes wherein the head assembly includes pressure cap aligned with the central axis.

In some implementations, the golf course grabbing device further includes an actuating shaft coupled to the handle and to the pressure cap, wherein the actuating shaft extends through a channel of the pivot plate to the pressure cap.

In some implementations, the golf course grabbing device further includes further comprising a spring located at least partially between the pivot plate and the pressure cap, wherein contact of the pressure cap with the tee marker is configured to compress the spring and to adjust a position of the plurality of elongated members.

In some implementations, the golf course grabbing device further includes wherein the tee marker includes a ground engaging mechanism having a tee marker axis and alignment of the device central axis with the tee marker axis aligns the pressure cap with the tee marker axis.

In some implementations, the golf course grabbing device further includes wherein the moveable section includes a first position and a second position, wherein the first position compresses the spring and the elongated members move toward the device central axis and the second position decompresses the spring and the elongated members move away from the device central axis.

In some implementations, the gold course grabbing device further includes wherein the pressure cap is configured to exert an at least partially downward force on the tee marker.

In a further implementation, there is provided a method of moving a tee marker having a ground engaging mechanism from a first location to a second location. The method includes: positioning a head assembly of a grabbing device at least partially around the tee marker located at the first location; squeezing a handle of the grabbing device to an at least partially closed position around the tee marker; moving the grabbing device in an at least partially upward direction to remove the tee marker from the ground; transporting the tee marker to the second location; and inserting the ground engaging mechanism into the ground with the grabbing device.

In some implementations, the method includes locking the ground engaging device after removing the tee box marker from the ground.

The above and other features will become apparent from the following description and accompanying drawings.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side perspective view of a grabbing device including a head assembly and a handle, said grabbing device configured to grab, transport, and release golf tee markers;

FIG. 2 is an exploded side view of the grabbing device of FIG. 1;

FIG. 3 is a close-up side view of the handle of the grabbing device of FIG. 1 including a moveable section and a fixed section;

FIG. 4 is a close-up side view of the head assembly of the grabbing device of FIG. 1;

FIG. 5 is a side view of the grabbing device of FIG. 1 and a tee marker with a ground engaging mechanism placed in a ground surface; and

FIG. 6 is a method for using a grabbing device to remove one or more golf tee markers and insert the one or more golf tee markers in the desired location of the tee box.

### DETAILED DESCRIPTION

For the purposes of promoting an understanding of the principles of the present disclosure, reference will now be made to the implementations described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

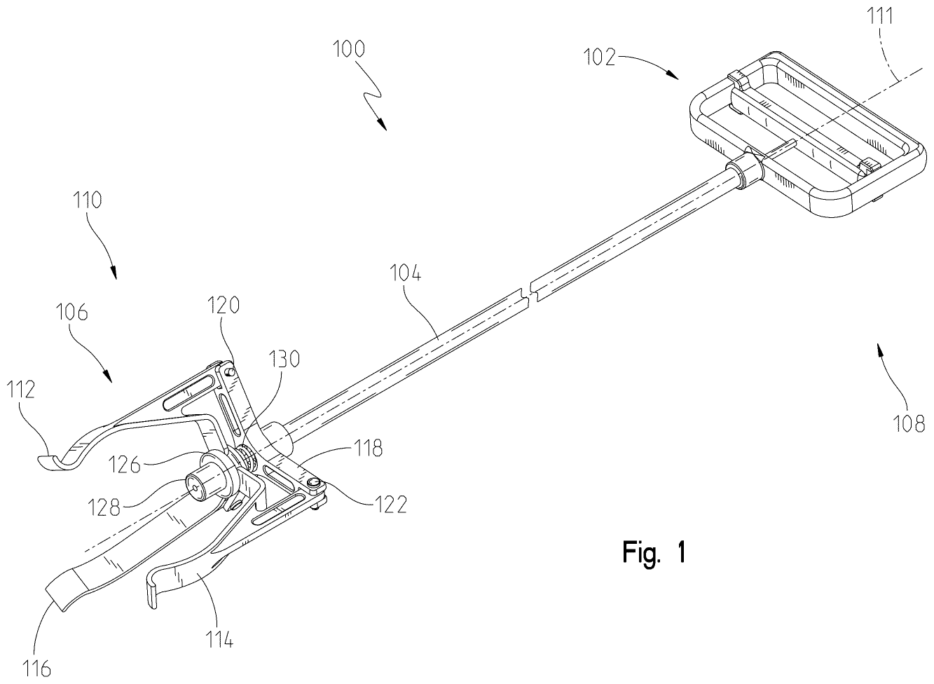

Referring to FIG. 1, a side perspective view of a grabbing device 100 is illustrated. The grabbing device 100 may include a handle 102, a main shaft 104, and a head assembly 106. The handle 102 may be located at a proximal end 108 of the grabbing device 100, the head assembly 106 may be located at a distal end 110 of the grabbing device, and the main shaft 104 may be located therebetween. The grabbing device 100 may additionally have a central axis 111 that may extend at least from the proximal end 108 of the grabbing device 100 to the distal end 110. As described herein, the grabbing device may be considered to include a grabbing tool, grabbing implement, or grabbing instrument.

The head assembly 106 may include a first elongated member 112, a second elongated member 114, and a third elongated member 116. The elongated members 112, 114, 116 may be coupled to a pivot plate 118. In one implementation, the first elongated member 112 may be coupled to the pivot plate 118 with a first clevis pin 120, the second elongated member 114 may be coupled to the pivot plate 118 with a second clevis pin 122, and the third elongated member 116 may be coupled to the pivot plate 118 with a third clevis pin 124. In some implementations the elongated members 112, 114, 116 may be one or more of arms, scoops, calipers, tongs, blades, or cups. The elongated members 112, 114, 116 may be any device known in the art for engaging with or grabbing another device. In some examples, elongated members 112, 114, 116 may be coupled to a pad of rubber or to a pad that includes rubber and the rubber may aid in gripping.

The head assembly may further include an actuating plate 126, a pressure cap 128, and a spring 130. The pressure cap may be located towards the distal end 110 of the shaft 104 and it may be coupled to the shaft 104. The actuating plate may be coupled to the shaft 104 and may be adjacent to the pressure cap 128 and located closer to the proximal end 108 of the grabbing device 100 relative to the pressure cap 128. The spring 130 may be located at least partially within the pivot plate 118 and may be located closer to the proximal end 108 of the grabbing device 100 relative to the actuating plate 126. In some examples, the pressure cap may be coupled to a pad of rubber or to a pad that includes rubber, and the rubber may aid in gripping. Other components of the grabbing device 100 may also be coupled to a pad that includes rubber.

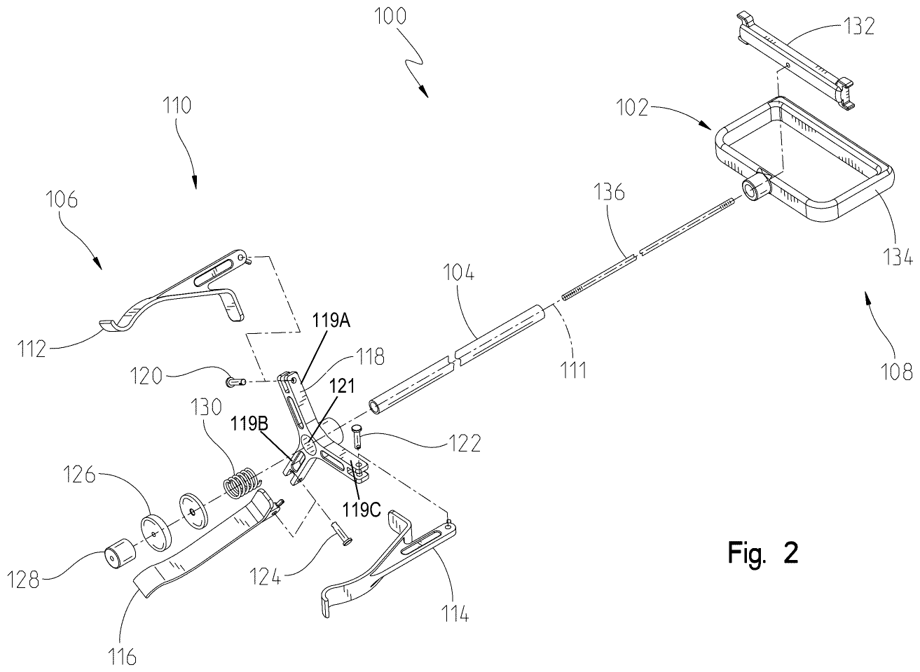

Referring now to FIG. 2, an exploded side perspective view of the grabbing device 100 is illustrated. Similar to FIG. 1, FIG. 2 illustrates the grabbing device 100 with the handle 102, main shaft 104, and head assembly 106 wherein the handle 102 is located at the proximal end 108 of the grabbing device 100 and the head assembly 106 located at the distal end 110 of the grabbing device 100. The grabbing device 100 may also have a central axis 111. Also similar to FIG. 1, the head assembly 106 of FIG. 2 may include three elongated members 112, 114, 116, coupled to the pivot plate 118. In one implementation, the pivot plate 118 includes arms 119A, 119B, and 119C extending from a channel 121. In some implementations, the arms 119A, 119B, and 119C are spaced equally about the channel 121. In other implementations, having two or more arms, each of the arms are space equally about the channel 121. In some implementations, the elongated members 112, 114, 116 may be coupled to the pivot plate 118 with clevis pins 120, 122, 124. The head assembly 106 may further include the actuating plate 126, pressure cap 128, and spring 130.

As illustrated in FIG. 2, the grabbing device may include a handle 102 with a moveable section 132 and a fixed section 134. The moveable section may be coupled to an actuating shaft 136. In some implementations the handle may also include a stop sleeve and a hex nut. The stop sleeve may be located within the fixed section and located closer to the distal end 110 relative to the moveable section 132 of the handle 102. The stop sleeve may be configured to prevent the moveable section 132 from moving towards the distal end 110 after the moveable section 132 contacts the stop sleeve.

The grabbing device 100 may include an actuating shaft 136. The actuating shaft 136 may positioned at least partially within the main shaft 104, and the actuating shaft 136 may be coupled to the moveable section 132 of the handle 102 at the proximal end 108 and coupled to the pressure cap 128 at the distal end 110. The actuating shaft 136 may be moveable relative to the main shaft 104.

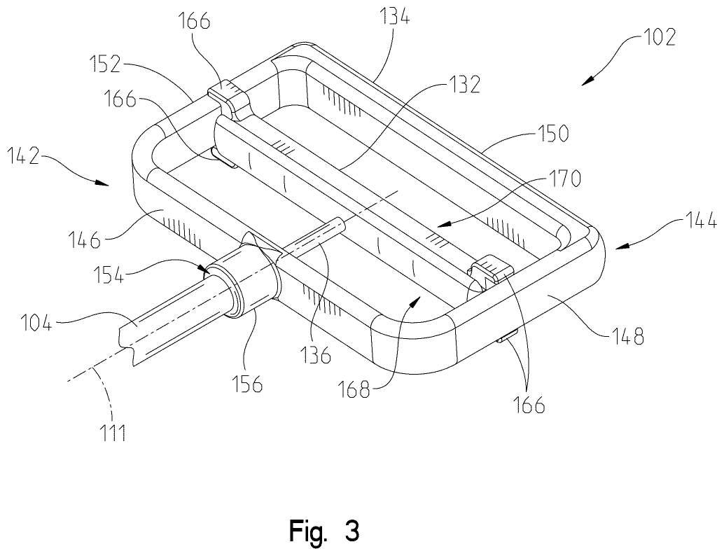

FIG. 3 illustrates a close-up view of the handle 102 with a moveable section 132 and a fixed section 134. The handle 106 may have a distal end 142 and a proximal end 144. The fixed section 134 may be rectangular-shaped with rounded corners. More specifically, the fixed section 134 may have a first side member 146, a second side member 148, a third side member 150, and a fourth side member 152, wherein the side members 146, 148, 150, 152 are positioned in a rectangular shape with rounded corners. The first side member 146 may be at least partially parallel to the third side member 150, and both the first and third side members 146, 150 may be at least partially perpendicular to the device central axis 111. The second side member 148 may be at least partially parallel to the fourth side member 152, and both the second and fourth side members 148, 152 may be at least partially parallel to the device central axis 111. The first side member 146 may be positioned closer to the distal end 142 of the handle 102 relative to the third side member 150. In the illustrative implementation the four side members 146, 148, 150, 152 may be four sections of a single piece or component. In other implementations, the four side members 146, 148, 150, 152 may be separate segments wherein each segment is coupled to one or more other segments thereby creating the rectangular shape.

The fixed section 134 may have a first aperture 154 that may be located in the first side member 146 and positioned between the second side member 148 and the fourth side member 152. In some implementations, the first section 146 may include a component that extends from the first side member 146 towards the distal end 142 of the handle 102, hereinafter referred to as a collar 156. In some implementations, the first aperture 154 may extend through both the collar 156 and the first side member 146. In other implementations, there may be a third aperture (not pictured) in the first side member 146, wherein the third aperture may have a smaller diameter than the first aperture 154. In these implementations, the first aperture 154 may be configured such that the main shaft 104 may be located at least partially in the first aperture 154, but the main shaft 104 has a larger outer diameter than the diameter of the third aperture such that the main shaft 104 may not be located in the third aperture.

The fixed section 134 of the handle 102 may also have a second aperture that may be located in the third side member 150 and may be positioned between the second side member 148 and the fourth side member 152. The second aperture may be configured such that the actuating shaft 136 may at least partially move through the second aperture. The second aperture may have a larger diameter than the actuating shaft 136 so the actuating shaft 136 may at least partially move through the second aperture. The second aperture may have a smaller diameter than an exterior diameter of the hex nut. The exterior diameter of the hex nut may be defined by the distance between opposing corners of the hex nut, commonly referred to as the width across corners; or by the distance between opposing flat portions, commonly referred to as the width across flats.

In some implementations the handle 102 may include a first hex nut and a second hex nut. The first and second hex nuts may be coupled to the actuating shaft 136, and may be located towards the proximal end 144 of the handle 102 relative to the moveable section 132. In some examples a portion of the actuating shaft 136 may be threaded such that the one or more hex nuts may be threaded onto the actuating shaft 136. In other examples, the hex nuts may be coupled by a weld joint, glue, solder, riveting, or any other method known in the art. While hex nuts are disclosed herein, other fasteners and fastening methods are considered herein.

The handle 102 may also have a moveable section 132 which may include an aperture, finger grooves, and protruding members 166. The moveable section 132 may have a distal side 168 and a proximal side 170, and the moveable section 132 may be at least partially positioned within the fixed section 134. In some examples, the moveable section may be positioned between the first side member 146 and the third side member 150.

The diameter of the moveable section aperture may be larger than the outer diameter of the actuating shaft 136 and the aperture may be configured so the actuating shaft 126 may at least partially extend through the aperture. The aperture may be co-axial with the device central axis 111, such that the central axis 111 may pass through a center portion of the aperture. The diameter of the moveable section aperture may be smaller than the diameter of one or more of the hex nuts

The finger grooves may be concave shaped grooves in the moveable section 132 wherein the central portion of each finger groove is located closer to the proximal end 144 of the handle 102 than the edges of each finger groove. The finger grooves may be configured so a human finger may be placed in or on each finger groove. In one example, the finger grooves may be positioned on the distal side 168 of the moveable section 132. In the illustrated implementation there may be four finger grooves. However, in some implementations there may be zero finger grooves, one finger groove, two finger grooves, three finger grooves, or more than four finger grooves. While the finger grooves of the illustrative implementation are located on the distal side 168 of the moveable section 132, in some examples the finger grooves may not be on the distal or proximal side 168, 170 of the moveable section 132 and instead may be located in apertures located in the moveable section 132.

The protruding members 166 may extend from the moveable section 132 towards the second or fourth side members 148, 152. In the illustrative implementation of FIG. 3, the moveable section 132 may include four protruding members 166, wherein two protruding members 166 may extend towards the second side member 148 and two other protruding members 166 may extend towards the fourth side member 152. The protruding members 166 may extend at least partially past a portion of the second and fourth side members 148, 152. In one example, no portion of the moveable section 132 may extend beyond a portion of the second or fourth side members 148, 152 except for the protruding members 166. The protruding members 166 may maintain the moveable section 132 in a parallel position relative to the first and third side member 146, 150.

Still referring to FIG. 3, the stop sleeve may be located between the first side member 146 and the moveable section 132. The stop sleeve may be coaxial to the device central axis 111. The stop sleeve may have an aperture extending therethrough, and may have an interior diameter that is larger than the outer diameter of the actuating shaft 136. The stop sleeve may be configured so the actuating shaft 136 may pass through the stop sleeve. The stop sleeve may have a larger outer diameter than the diameter of the moveable section aperture 166, such that the stop sleeve may not move into the moveable section aperture. In some examples, the stop sleeve may have a larger outer diameter than the fixed section first aperture 154, such that the stop sleeve may not move within the fixed section first aperture 154. In some examples the first side member 146 may have both a first aperture 154 and a third aperture wherein the first aperture 154 is located towards the distal end of the handle 102 relative to the third aperture. In these examples, the third aperture may be adjacent to the stop sleeve, and the outer diameter of the stop sleeve may be larger than the diameter of the third aperture, so the stop sleeve may move into the third aperture.

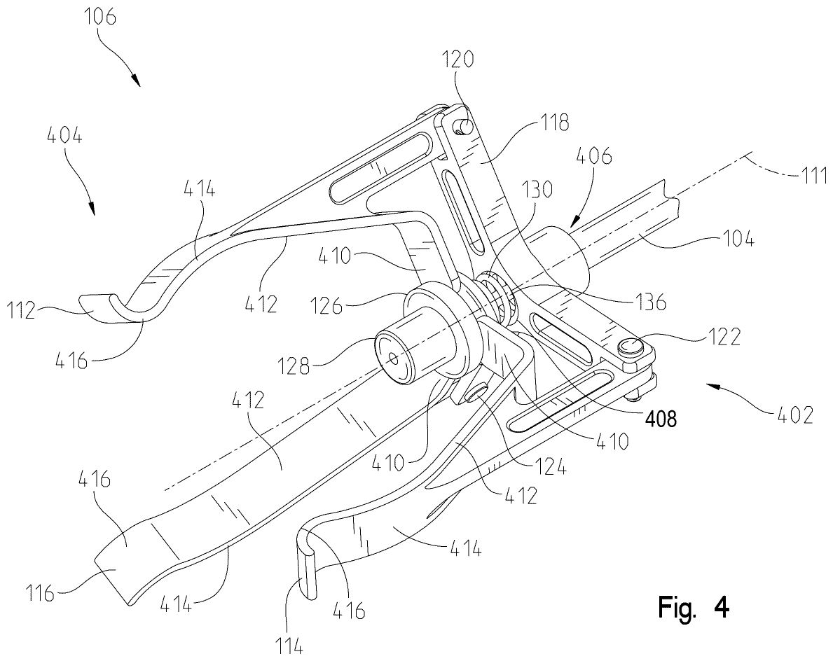

Referring now to FIG. 4, the head assembly 106 of the grabbing device 100 is illustrated. The head assembly 106 may include the pivot plate 118, the first, second, and third elongated members 112, 114, 116, the spring 130, the actuating plate 126, and the pressure cap 128. The head assembly may have a proximal end 402 and a distal end 404. The head assembly may be coupled to the main shaft 104 at the head assembly proximal end 402. In some examples the pivot plate 118 may be positioned at the head assembly proximal end 402 and the main shaft 104 may be coupled to the pivot plate 118.

The pivot plate may include a first aperture 406 and a second aperture 408. The first aperture 406 and the second aperture 408 form part of the channel 121. The pivot plate first aperture 406 may be located closer to the head assembly proximal end 402 relative to the pivot plate second aperture 408. In some implementations, the pivot plate first aperture 406 may have a diameter that is larger than the pivot plate second aperture 408. In other implementations, the pivot plate first aperture 406 may have a diameter that is equal to the diameter of the pivot plate second aperture 408. In still another implementation, the pivot plate first aperture 406 may have a diameter that is smaller than the diameter of the pivot plate second aperture 408. In some examples, there may be only one pivot plate aperture 406, and that aperture may extend from the proximal end 402 of the pivot plate 118 to the distal end 404 of the pivot plate 118.

The pivot plate 118 may be coupled to the first, second, and third elongated members 112, 114, 116. In one example, the pivot plate 118 may be coupled to the proximal end 402 of the first, second, and third elongated members 112, 114, 116. The pivot plate may be pivotably coupled to the elongated members 112, 114, 116 such that the elongated members 112, 114, 116 may pivot. In the illustrative implementation the first elongated member 112, may be coupled to the pivot plate 118 with a first clevis pin 120, the second elongated member 114 may be coupled to the pivot plate 118 with a second clevis pin 122, and the third elongated member 116 may be coupled to the pivot plate with a third clevis pin 124. While the illustrative implementation illustrates that clevis pins 120, 122, 124 couple the elongated members 112, 114, 116 to the pivot plate 118, coupling devices other than clevis pins 120, 122, 124 may be used, such as, for example, rings, clips, fasteners, another type of pin, or any method known in the art for pivotably coupling two or more components.

The elongated members 112, 114, 116 may include an impact section 410, a straight section 412, a first curvature 414, and a second curvature 416. In some examples, the first curvature 412 may be concave shaped relative to the device central axis 111, and the second curvature may be convex shaped relative to the device central axis 111.

The impact section 410 may be located closer to the head assembly proximal end 402 relative to the actuating plate 126, and the impact section 410 may extend towards the device central axis 111. In one example, the impact section 410 is orthogonal to the device central axis 111. The impact section 410 may be adjacent to the straight section 412 and may be located closer to the distal end 404 than the impact section 410. In one example, the straight section 412 may have an interior face that may be linearly shaped. In other examples, the straight section 412 may have a concave shape relative to the device central axis 111. The straight section 412 may extend from the impact section 410 to the first curvature section 414. The first curvature section 414 may be located closer to the head assembly distal end 404 relative to the straight section 412. The first curvature section 414 may have a concave shape relative to the device central axis 111. The first curvature section 414 may be located adjacent to the second curvature section 416. The second curvature section 416 may be convex shaped relative to the device central axis 111. In other words, the distal end 404 of the elongated members 112, 114, 116 may at least partially diverge away from the device central axis 111.

In some examples, the head assembly 106 may transition between an open position, a closed position, and positioned therebetween. FIG. 4 illustrates one example of the head assembly 106 in an open position. When the head assembly 106 is in the closed position, the elongated members 112, 114, 116 may be located closer to the device central axis 111 relative to the location of the elongated members 112, 114, 116 when the head assembly 106 is in the open position. More specifically, the straight section 412, first curvature section 414, and second curvature section 416 of the elongated members 112, 114, 116 may be located closer to the device central axis 111 when the head assembly 106 is in the closed position relative to these sections 412, 414, 416 of the elongated members 112, 114, 116 when the head assembly 106 is in the open position.

In some examples, the head assembly 106 may move from the open position to the closed position. In these examples, the elongated members 112, 114, 116 may correspondingly move towards the device central axis 111. More specifically, when the head assembly 106 moves from the open position to the closed position the straight section 412, first curvature section 414 and second curvature section 416 of the three elongated members 112, 114, 116 may move closer to the device central axis 111 relative to when the head assembly 106 remains in the open position. In some implementations, the head assembly 106 may move from the closed position to the open position. In these implementations the elongated members 112, 114, 116 may move away from the device central axis relative to location of the elongated members 112, 114, 116 when the head assembly 106 is in the closed position. In other words, when the head assembly 106 moves from the closed to the open position, the straight section 412, first curvature section 414 and second curvature section 416 of the elongated members 112, 114, 116 may move away from the device central axis 111 relative to when the head assembly 106 remains in the closed position. While three elongated members are disclosed herein, other examples may include two elongated members. Additional examples may include more than three elongated members.

The head assembly 106 may also include the spring 130, which may be adjacent to the impact section 410 of the elongated members 112, 114, 116. The spring 130 may be located towards the proximal end of the head assembly 402 relative to the impact section 410 of the impact section 410 of the elongated members 112, 114, 116. The spring 130 may extend into the pivot plate first aperture 406. In some examples, the spring 130 may be located adjacent to the elongated members 112, 114, 116. The spring 130 may be co-axial with the actuating shaft 136 and the spring 130 may have a diameter that is larger than the actuating shaft 136 such that the actuating shaft 136 may be positioned inside the spring 130 and extend therethrough. When the head assembly 106 is in the open position, the spring 130 may be decompressed. When the head assembly 106 is in the closed position, the spring 130 may be compressed by the impact section 410 of the elongated members 112, 114, 116.

The head assembly 106 may further include the actuating plate 126 and pressure cap 128. The pressure cap 128 may be located towards the distal end of the head assembly 404 relative to the actuating plate 126, and the actuating plate 126 may be located towards the distal end of the head assembly 404 relative to the impact section 410 of the elongated members 112, 114, 116. The impact section 410 of the elongated members 112, 114, 116 may be distal 404 to and adjacent to the spring 130. In one example, the actuating plate 126 may have an aperture (not pictured) and the actuating plate 126 aperture may have an interior diameter that is larger than the exterior diameter of the actuating shaft 136. Additionally, the actuating plate 126 may be configured such that it may contact the impact section 410 of all three elongated members 112, 114, 116 simultaneously. In one example, the actuating plate 126 may have a circular shape, and the exterior diameter of the actuating plate 126 may be configured so the actuating plate 126 may contact the impact section 410 of each of the elongated members 112 114, 116 simultaneously. The actuating shaft 136 may be positioned at least partially through the actuating plate 126 aperture. In some examples, the actuating shaft 136 may extend entirely through the actuating plate 126 and may also extend partially through the pressure cap 128. In some examples the pressure cap 128 may be fixedly coupled to the actuating shaft 136, such that the pressure cap 128 moves axially with the actuating shaft 136. In other words, when the actuating shaft 136 moves towards the head assembly distal end 404, the pressure cap 128 may likewise move towards the head assembly distal end 404, and when the actuating shaft 136 moves towards the head assembly proximal end 402, the pressure cap 128 may likewise move towards the head assembly distal end 404.

In some implementations, the head assembly 106 may be removable. In this implementation, the pressure cap 128, actuating plate 126, spring 130, and pivot plate 118 may be removed 118 and replaced with an alternative head assembly. In some examples, the elongated members 112, 114, 116 of the alternative head assembly may have different shapes than the elongated members 112, 114, 116 in the illustrated implementation of FIG. 4. In one implementation, the alternative head assembly may have a first curvature section 414 that may extend further from the device central axis 111 relative to the illustrated implementation in FIG. 4 and the second curvature section 416 may converge closer to the device central axis 111 relative to the illustrated implementation of FIG. 4. In other implementations, the alternative head assembly 106 may have a different number of elongated members, such as two, four, or more than four elongated members. In one example, the head assembly 106 may have four elongated members wherein two opposing elongated members are closer to the device central axis 111 relative to the other two opposing elongated members in both the open and closed position. In this example, the elongated members may be used to grab a tee marker with a rectangular or cylindrical shape, such as, for example, a log. In another implementation the head assembly 106 may have four elongated members wherein all the members are similarly shaped and have similar lengths along the device central axis 111. In this implementation, the head assembly 106 may be designed to grab a tee marker with a square shape.

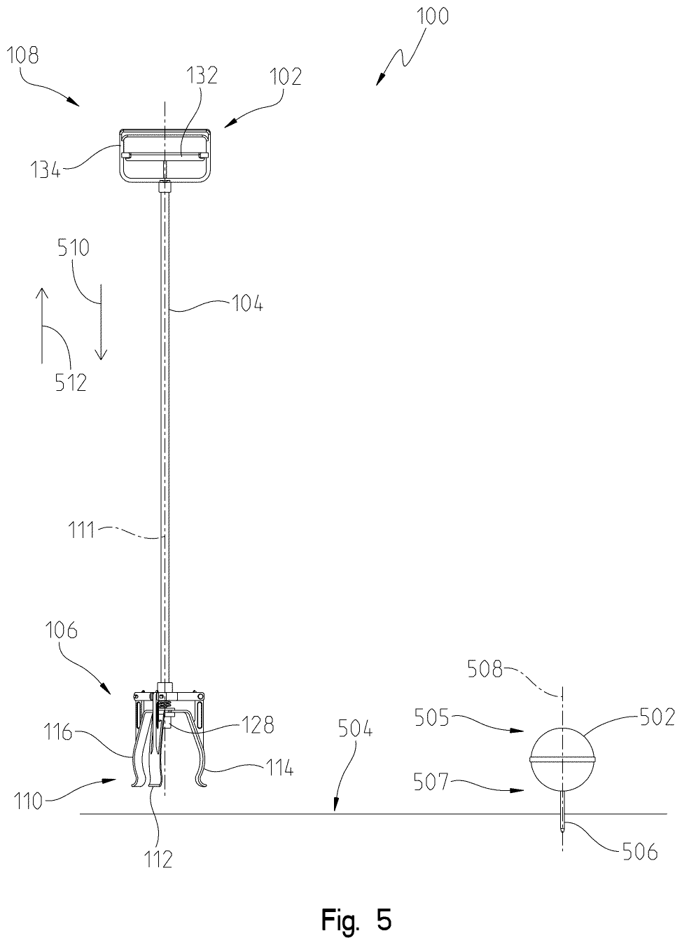

Referring now to FIG. 5, the grabbing device 100 is illustrated with a tee marker 502 positioned in a ground surface 504. As described above, the grabbing device 100 may include the handle 102, main shaft 104, and head assembly 106. The tee marker 502 may include a top end 505 and a bottom end 507, where the bottom end 507 of the tee marker 502 may be coupled to a ground engaging mechanism 506. The ground engaging mechanism 506 may be, for example, a rod or spike configured to penetrate or enter the ground surface 504. In some examples the tee marker 502 may have a tee marker axis 508 and the tee marker axis may extend vertically relative to the ground surface 504. In some examples, the tee marker axis 508 may be perpendicular to the ground surface 504. In some examples the tee marker axis 508 may be askew such that it is not perpendicular with the ground surface 504. In some examples the ground engaging mechanism 506 may be positioned in the ground surface 504. In other examples the tee marker 502 may not have a ground engaging mechanism 506 and may be positioned on the ground surface 504.

In some implementations, the grabbing device 100 may remove the tee marker 502 from the ground surface 502. The grabbing device 100 may be positioned over the tee marker 502 and the device central axis 111 may be at least partially aligned with the tee marker axis 508. In some examples, the device central axis 111 and the tee marker axis 508 may be parallel. In other examples, the device central axis 111 and the tee marker axis 508 may not be parallel. In one example, the device central axis 111 may be slightly askew relative to the tee marker axis 508.

The grabbing device 100 may be moved in a downward direction 510 to the tee marker 502. In one example, the grabbing device may at least partially contact the tee marker 502. In some examples, all three elongated members 112, 114, 116 may contact the tee marker 502 and may extend beyond the bottom end 507 of the tee marker 502. In another example, one or more of the elongated members 112, 114, 116 may contact the tee marker and may extend beyond the bottom end 507 of the tee marker 502. In another example, none of the elongated members 112, 114, 116 may contact the tee marker 502 when the grabbing device 100 is moved to the tee marker, and instead the tee marker may contact the pressure cap 128 and each elongated member 112, 114, 116 may be located farther from a central portion of the tee marker 502 relative to any portion of the tee marker 502.

In some implementations, the distal end 404 of the head assembly 106 may be positioned closer to the tee marker axis 508 relative to any portion of the tee marker 502. In these implementations, the convex or divergent shape of the distal end 404 of the elongated members 112, 114, 116 may facilitate the head assembly 110 moving to a position wherein the elongated members 112, 11,4, 116 extend beyond the bottom end 507 of the tee marker 502. In one such implementation, the convex or divergent shape of the distal end 404 of the elongated members 112, 114, 116 may enable the elongated members 112, 114, 116 to slide over the tee marker 502 with less force applied to the grabbing device 100 in the downward direction 510 relative to elongated members 112, 114, 116 without the convex or divergent shaped distal end 404.

The moveable section 132 of the handle 102 may be moved in an upward direction 512. Moving the moveable section 132 of the handle 102 may correspondingly move the actuating shaft 136 in the upward direction 512, and the pressure cap 128 and actuating plate 126 may move therewith. The actuating plate 126 may contact the impact section 410 of each elongated member 112, 114, 116 and may at least partially move the impact section 410 of each elongated member 112, 114, 116 towards the proximal end 402 of the head assembly 106. When the impact sections 410 of the elongated members 112, 114, 116 move towards the proximal end 402 of the head assembly 106, the impact section 410 may compress the spring 130. Additionally, when the impact sections 410 move towards the proximal end 402, each elongated member 112, 114, 116 may pivot towards the device central axis 111 thereby moving the head assembly 106 into an at least partially closed position. When the head assembly 106 is in an at least partially closed position the head assembly 106 may engage, or grab, the tee marker 502.

With the moveable section 132 of the handle 102 disposed towards the proximal end 108 of the grabbing device 100, thereby maintaining the head assembly 106 in the at least partially closed position, the grabbing device 100 may be moved in an upward direction, pulling the ground engaging mechanism 506 out of the ground surface 504 and lifting the tee marker 502 in the upward direction 512.

In some implementations, the grabbing device 100 may insert the tee marker 502 into the ground surface 504. More specifically the grabbing device 100 may insert the ground engaging mechanism 506 of the tee marker 504 into the ground surface 504. In these implementations, the tee marker 502 may be at least partially positioned within the head assembly 106 and the moveable section 132 of the handle 102 may be disposed towards the proximal end 108 of the grabbing device 100. The moveable section 132 of the handle 102 being disposed towards the proximal end 108 of the grabbing device 100 may maintain the grabbing device 100 in an at least partially closed position about the tee marker 502 and the head assembly 106 may be engaged with the tee marker 502.

The grabbing device 100 may then move to a location where the tee marker 502 is desired to be located. The grabbing device 100 may be oriented such that one or more of the device central axis 111 and the tee marker axis 508 are vertically positioned with respect to the ground surface 504. In some examples, one or more of the device ventral axis 111 and the tee marker axis may be perpendicular to the ground surface 504. In some examples, the grabbing device 100 may be oriented such that the distal 110 end of the grabbing device 100 is closer to the ground surface 504 relative to the proximal end 108.

The grabbing device 100 may then be moved in the downward direction 510 and may push, or exert a force on, the tee marker 508. The grabbing device 100 may push the ground engaging mechanism 506 at least partially into the ground surface 504. In one example, the pressure cap 128 may exert a force in the downward direction 510 onto the tee marker 502. In some examples, the elongated members exert a downward 510 force or an at least partially downward 510 force on the tee marker 502. In addition to a downward 510 force the elongated members 112, 114, 116 may exert a radial force on the tee marker 502.

When the grabbing device pushes the ground engaging mechanism 506 of the tee marker 508 into the ground 504, the device central axis 111 and the tee marker axis 508 may be parallel and horizontally aligned with respect to the ground surface 504, and this may be referred to as a “collinear configuration.” Inserting the ground engaging mechanism 506 into the ground surface 504 may be less strenuous in the collinear configuration relative to a configuration where the device central axis 111 and the tee marker axis 508 are in a non-collinear configuration. In other words, in the collinear configuration the amount of downward 510 force required to push the ground engaging mechanism 506 of the tee marker 502 into the ground surface 504 may be less than in a non-collinear configuration. Non-collinear configurations may include configurations where the device central axis 111 and the tee marker axis 508 are parallel but are not horizontally aligned with respect to the ground surface 405 and configurations where the device central axis 111 is not parallel relative to the tee marker axis 508. In some examples, when the grabbing device pushes the tee marker 508 into the ground surface 504, the central axis 111 and the tee marker axis 508 may be parallel. In some examples, the device central axis 111 and the tee marker axis 508 may be slightly askew, such that the device central axis 111 and the tee marker axis 508 are not parallel.

While the grabbing device 100 pushes the ground engaging mechanism 506 into the ground surface 504, the moveable section 132 of the handle 106 may remain disposed towards the proximal end 108 of the grabbing device 100. Thus, the head assembly 106 may remain in the at least partially closed position. Once the tee marker 502 is positioned in the desired position and the ground engaging mechanism is positioned to a desired depth under the ground surface 504, the grabbing device may release the tee marker 502. In some examples, the moveable section 132 of the handle 102 may not be disposed towards the proximal end 108 of the grabbing device 100 when the grabbing device 100 pushes the ground engaging mechanism 506 into the ground surface 504, and instead the head assembly 106 may be in an open or partially open position. In these examples, the elongated members 112, 114, 116 may be sufficiently positioned towards the device central axis 111 when the head assembly 106 is in the open or partially open position such that the tee marker 502 may be inserted into the ground surface 504.

When the grabbing device 100 releases the tee marker 502, the moveable section 132 of the handle 102 may no longer be disposed towards the proximal end 108 of the grabbing device 100. In one example, the spring 130 may move the moveable section 132 of the handle 102. In this example, when the handle 102 is released the compressed spring 130 may move into a less compressed or a decompressed position. Upon at least partially decompressing, the spring 130 may move the impact section 410 towards the distal end 110 of the grabbing device 100, and the impact section 410 may move the actuating plate 126 and the pressure cap 128 towards the distal end 110. The impact section 410 moving towards the distal end 110 may pivot the elongated members 112, 114, 116 away from the device central axis 111. When the elongated members 112, 114, 116 are moved away from the device central axis 111, the grabbing device 100 may be in an open or partially open position.

The pressure cap 128 may be coupled to the actuating shaft 136 and when the pressure cap 128 moves towards the distal end 110 the actuating shaft 136 may correspondingly move towards the distal end 110. The one or more hex nuts may be coupled to the actuating shaft 136, and the one or more hex nuts may move with the actuating shaft 136 towards the distal end 110 thereby moving the moveable section 132 of the handle 102 at least partially towards the distal end 110. In some examples, the stop sleeve may limit the extent in which the moveable section 132 may move towards the distal end 110. For example, the moveable section 132 may move towards the distal end 110 and may contact the stop sleeve, whereupon the moveable section 132 may be stopped from moving further towards the distal end 110.

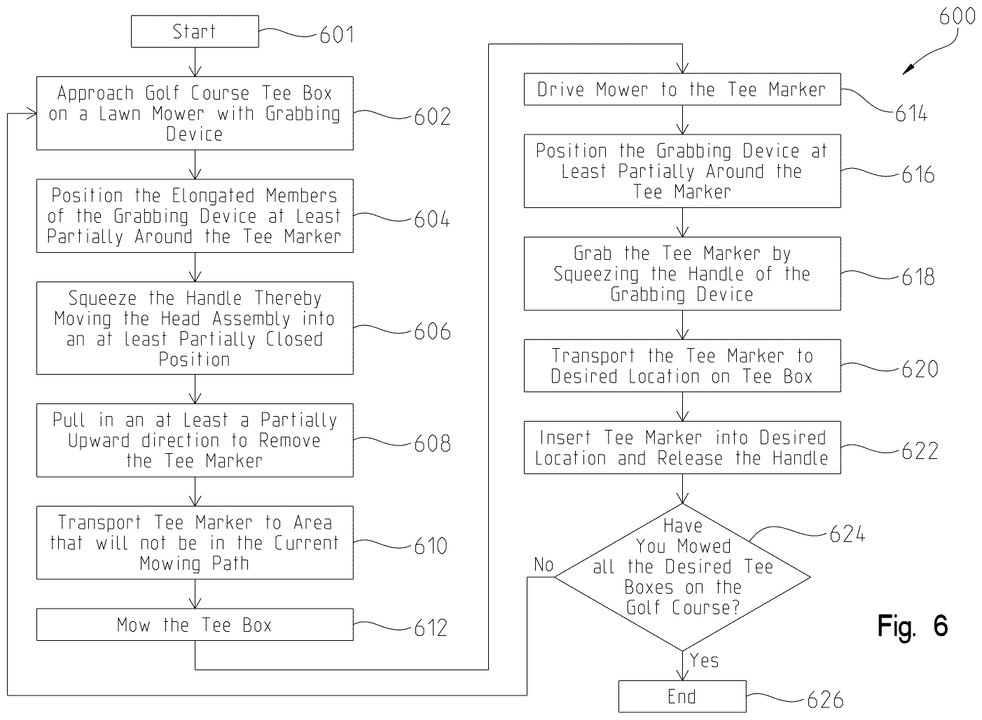

FIG. 6 is one implementation of a method 600 for removing and inserting the tee marker 502 with the grabbing device 100. Beginning at block 601, an operator may approach a golf course tee box on a lawn mower with the grabbing device 100 (block 600). The operator may approach the tee box marker 502 the operator desires to move, and the operator may position the head assembly 106 of the grabbing device 100 at least partially around the tee marker 502. More specifically, the operator may position one or more elongated members 112, 114, 116 at least partially around the tee marker 502 (block 604). In some examples, the distal end 404 of the elongated members 112, 114, 116 may be convex shaped relative to the tee marker axis 508. In an example, the distal end 404 of the elongated members 112, 114, 116 may diverge from the tee marker axis 508. This convex or divergent shape of the elongated members 112, 114, 116 relative to the tee marker axis 508 may facilitate the elongated members 112, 114, 116 sliding over the tee marker 502. In some examples, the elongated members 112, 114, 116 may be positioned at least partially around the tee marker 502 without sliding over the tee marker 502.

Once the elongated members 112, 114, 116 are positioned at least partially around the tee marker 502 (block 604) the operator may squeeze the handle 102 thereby moving the head assembly 106 into an at least partially closed position. In some examples, the operator may move the moveable section 132 of the handle 102 towards the proximal end 108 of the grabbing device 100 which may pivot the elongated members 112, 114, 116 towards the device central axis 111, thereby at least partially closing the head assembly 106 about the tee marker 502. When the head assembly 106 is at least partially closed about the tee marker 502, the elongated members 112, 114, 116 may be engaged with the tee marker 502 thereby grabbing the tee marker 502.

The operator may then pull the grabbing device 100 in an at least partially upward direction 512 which may remove the tee marker 502 from the ground surface 504 (block 608). The operator may then transport the tee marker 502 to an area that will not be in the current mowing path (block 610), also referred to herein as a second location. In some examples, the tee box may have more than one tee marker 508, and all tee markers 508 in the tee box may be removed before mowing the tee box (box 612). In one example, the head assembly 106 may remain in the closed or partially closed position while the operator transports the tee marker 502 to the second location that will not be in the current mowing path. Once the operator transports the tee marker 502 to the second location (block 610), the operator may release the tee marker 502 into this area. In one example, the operator may insert the ground engaging mechanism 506 of the tee marker 502 into the ground surface 504 of the second location. In other examples, the operator may simply place or drop the tee marker 502 on the ground surface 504 of the second location. After removing the tee marker 502 and transporting it to the second location, the operator may mow the tee box (block 612).

Once the operator mows the tee box (block 612), the operator may drive the mower to the tee marker 502 located in the second location (block 614). The operator may position the grabbing device 100 at least partially around the tee marker 502 (block 616) and may grab the tee marker 502 by squeezing the handle 102 of the grabbing device 100 (block 618). When the operator squeezes the handle 102 of the grabbing device the grabbing device may move into a closed or partially closed position about the tee marker 502.

The operator may then transport the tee marker 502 to a desired location on the tee box (block 620). In some implementations, as the operator transports the tee marker 502 the grabbing device 100 may remain in a closed or partially closed position. In some examples, the operator may hold the moveable section 132 of the handle 102 towards the proximal end 108 of the grabbing device 100 to maintain the handle 102 in a closed or partially closed position. In other examples, the handle 102 may have a lock. In these other examples, the lock may be engaged and the moveable section 132 of the handle 102 may remain in the closed or partially closed position, or the lock may be disengaged and the moveable section 132 of the handle 102 may move into an open or partially open position.

Once the tee marker 502 is transported to the desired location on the tee box (block 620), the tee marker 502 may be inserted into the desired location and the handle may be released (block 622). In some examples, the tee marker 502 may include a ground engaging mechanism 506 and the ground engaging mechanism 506 may be inserted into the ground surface 504. When the handle 102 is released, the grabbing device may move into an open or partially open position. In some examples, the tee box may have more than one tee marker. In these examples, for each remaining tee marker 502 that was removed from the tee box, the operator may continue by driving the mower to the tee marker 502 (block 614), positioning the grabbing device 100 at least partially around the tee marker 502 (block 616), grabbing the tee marker 502 by squeezing the handle 102 of the grabbing device 100 (block 618), transporting the tee marker 502 to the desired location on the tee box (block 620), inserting the tee marker 502 into the desired location and releasing the handle 102 (block 622).

After the one or more tee markers 502 are inserted in their desired locations on the tee box, the operator may determine whether all the desired tee boxes on a golf course have been mowed (block 624). If all of the desired tee boxes on the golf course have been mowed (block 624), then the method 600 may end (block 626). If all of the desired tee boxes on the golf course have not been mowed, then the method 600 continues to block 602 and the operator approaches the golf course tee box on a lawn mower with the grabbing device 100 (block 602).

While the above describes example implementations of the present disclosure, these descriptions should not be viewed in a limiting sense. Rather, other variations and modifications can be made without departing from the scope and spirit of the present disclosure as defined in the appended claims.

1. A grabbing device for grabbing an object from a distance, the grabbing device comprising:
a handle having a moveable section and a fixed section, the moveable section being movably coupled to the fixed section;
a head assembly with a plurality of elongated members configured to grab an object; and
a shaft coupled to the handle at a proximal end of the shaft and removably coupled to the head assembly at a distal end of the shaft, wherein the head assembly may be removed and replaced with an alternative head assembly.

2. The grabbing device of claim 1, wherein each of the plurality of elongated members has a divergent distal end, and wherein each of the distal ends of the plurality of elongated members is configured to slide over the object.

3. The grabbing device of claim 2 wherein the head assembly includes a pivot plate and each of the plurality of elongated members is pivotably coupled to the pivot plate.

4. The grabbing device of claim 3 wherein the pivot plate includes a plurality of arms, wherein one of the plurality of elongated members is pivotally coupled to one of the plurality of arms.

5. The grabbing device of claim 4 wherein the pivot plate includes a channel extending through the pivot plate and each of the plurality of arms extends from the channel.

6. The grabbing device of claim 5 wherein the shaft includes an actuating shaft coupled to the moveable section of the handle.

7. The grabbing device of claim 6 further comprising a spring, wherein the actuating shaft extends through the spring and actuation of the moveable section compresses the spring to extend the plurality of arms toward a central axis defined by the device.

8. The grabbing device of claim 7 wherein the channel includes a first aperture and a second aperture, wherein the handle is coupled to the first aperture by a main shaft of the shaft and the spring is located in the second aperture.

9. The grabbing device of claim 7 wherein a release of the handle decompresses the spring and moves the plurality of elongated members away from the central axis.

10. The grabbing device of claim 8 further comprising a main shaft, wherein the actuating shaft is positioned at least partially within the main shaft and moveable relative to the main shaft.

11. The grabbing device of claim 9 wherein the fixed section of the handle is coupled to the main shaft.

12. A golf course grabbing device for grabbing a tee marker located on a golf course comprising:
a handle having a moveable section and a fixed section, the moveable section being movably coupled to the fixed section;
a main shaft coupled to the fixed section, the main shaft defining a device central axis;
a head assembly coupled to the main shaft, the head assembly including a pivot plate; and
a plurality of elongated members each of which is pivotally coupled the pivot plate, wherein each of the plurality of elongated members includes a divergent shape configured to engage the tee marker.

13. The golf course grabbing device of claim 12 wherein the head assembly includes a pressure cap aligned with the device central axis.

14. The golf course grabbing device of claim 13 further comprising an actuating shaft coupled to the handle and to the pressure cap, wherein the actuating shaft extends through a channel of the pivot plate and to the pressure cap.

15. The golf course grabbing device of claim 14 further comprising a spring located at least partially between the pivot plate and the pressure cap, wherein contact of the pressure cap with the tee marker is configured to compress the spring and to adjust a position of the plurality of elongated members.

16. The golf course grabbing device of claim 15 wherein the tee marker includes a ground engaging mechanism having a tee marker axis and alignment of the device central axis with the tee marker axis aligns the pressure cap with the tee marker axis.

17. The golf course grabbing device of claim 16 wherein the moveable section includes a first position and a second position, wherein the first position compresses the spring and the elongated members move toward the device central axis and the second position decompresses the spring and the elongated members move away from the device central axis.

18. The golf course grabbing device of claim 17 wherein the pressure cap is configured to exert an at least partially downward force on the tee marker.

19. A method of moving a tee marker, having a ground engaging mechanism, from a first location to a second location, the method comprising:
positioning a head assembly of a grabbing device at least partially around the tee marker located at the first location;
squeezing a handle of the grabbing device to an at least partially closed position around the tee marker;
moving the grabbing device in an at least partially upward direction to remove the tee marker from the ground;
transporting the tee marker to the second location; and
inserting the ground engaging mechanism into the ground with the grabbing device.

20. The method of claim 19 further comprising locking the ground engaging device after removing the tee box marker from the ground.
